(19) United States
(12) Patent Application Publication
(10) Pub. No.: US 2025/0251614 A1
(43) Pub. Date: Aug. 7, 2025

(54) OPTICAL ELEMENT DRIVING MECHANISM

(71) Applicant: TDK CORPORATION, Tokyo (JP)

(72) Inventors: Chuan-Min LEE, Taoyuan City (TW); Shu-Shan CHEN, Taoyuan City (TW); Pai-Jui CHENG, Taoyuan City (TW)

(21) Appl. No.: 18/664,529

(22) Filed: May 15, 2024

(30) Foreign Application Priority Data
Feb. 1, 2024 (CN) 202420254214.0

(51) Int. Cl. G02B 27/64; G01D 5/14

(52) U.S. Cl. CPC G02B 27/646; G01D 5/145

(57) ABSTRACT

An optical element driving mechanism is provided. The optical element driving mechanism includes a fixed assembly, a movable part, and a driving assembly. The fixed assembly has a main axis. The movable part is configured to be connected to an optical element, and the movable part is movable relative to the fixed assembly. The driving assembly is configured to drive the movable part to move relative to the fixed assembly.

### CROSS REFERENCE TO RELATED APPLICATIONS

This application claims the benefit of China Patent Application No. 202420254214.0, filed on Feb. 1, 2024, the entirety of which are incorporated by reference herein.

### BACKGROUND OF THE INVENTION

### Field of the Disclosure

The present disclosure relates to an optical element driving mechanism, and in particular it relates to an optical element driving mechanism with a piezoelectric element.

### Description of the Related Art

As technology has developed, many of today's electronic devices (such as smartphones) are equipped with a camera for photographic and video functionality. Users can capture photographs and record videos using the camera modules disposed in their electronic devices.

Today's design of electronic devices continues to follow the trend of miniaturization, meaning that the various components of the camera module and its structure must also be continuously reduced, so as to achieve miniaturization. In general, a driving mechanism in a camera module has a camera lens holder configured to hold a camera lens, and the driving mechanism can have the functions of auto focusing or optical image stabilization. However, although the existing driving mechanism can achieve the aforementioned functions of photographing or video recording, they still cannot meet all the needs of users.

Therefore, how to design a camera module that can perform autofocus, optical anti-shake and achieve miniaturization at the same time is topic nowadays that needs to be discussed and solved.

### BRIEF SUMMARY OF THE INVENTION

Accordingly, one objective of the present disclosure is to provide an optical element driving mechanism to solve the above problems.

According to some embodiments of the disclosure, an optical element driving mechanism is provided. The optical element driving mechanism includes a fixed assembly, a movable part, and a driving assembly. The fixed assembly has a main axis. The movable part is configured to be connected to an optical element, and the movable part is movable relative to the fixed assembly. The driving assembly is configured to drive the movable part to move relative to the fixed assembly.

According to some embodiments, the optical element driving mechanism further includes a first guiding assembly configured to guide the movable part to move relative to the fixed assembly. The first guiding assembly includes a first stabilizing element, a first supporting element, a first corresponding element and a first contact portion. The first supporting element and the first corresponding element are arranged along a first axis. The first guiding assembly further includes a second stabilizing element corresponding to the first stabilizing element. The first stabilizing element is configured to generate a first stabilizing force with the second stabilizing element, and the first stabilizing force is applied to the movable part. The first stabilizing force drives the movable part toward the first supporting element.

According to some embodiments, the first corresponding element has a first accommodating space configured to accommodate at least a portion of the first supporting element. The first contact portion is located on the first corresponding element and is configured to be in contact with the first supporting element. When viewed along the main axis, the fixed assembly with a polygonal structure has a first side and a second side. When viewed along the main axis, the first supporting element is located on the first side. When viewed along the main axis, the first stabilizing element is located on the first side. When viewed along the main axis, the minimum distance between the center of the first supporting element and the first central line of the first side is different from the minimum distance between the center of the first stabilizing element and the first central line.

According to some embodiments, when viewed along the main axis, the movable part has a polygonal structure, corresponding to the fixed assembly. When viewed along the main axis, the fixed assembly has a first corner. When viewed along the main axis, the first corner is located between the first side and the second side. When viewed along the main axis, the movable part has a second corner corresponding to the first corner. The second corner is located between the first side and the second side. The first supporting element is not disposed at the first corner. The second stabilizing element is disposed at the second corner.

According to some embodiments, the first stabilizing element includes one of the following: either a magnetic permeable element or a magnetic element. The second stabilizing element includes the other one; either the magnetic permeable element or the magnetic element. When viewed along the main axis, the minimum distance between the center of the first supporting element and the first central line of the first side is less than the minimum distance between the center of the first stabilizing element and the first central line. The first side is only provided with the first guiding assembly.

According to some embodiments, when viewed along the main axis, the movable part has a polygonal structure, corresponding to the fixed assembly. When viewed along the main axis, the fixed assembly movable part has a first corner. When viewed along the main axis, the first corner is located between the first side and the second side. When viewed along the main axis, the movable part has a second corner corresponding to the first corner. The second corner is located between the first side and the second side. The first supporting element, the first corresponding element and the first contact portion are located at the second corner. The first supporting element is located at the first corner.

According to some embodiments, the first contact portion has a first contact surface and a second contact surface. The first contact surface is connected to the second contact surface. The first contact surface and the second contact surface are configured to be in contact with the first supporting element. The first contact surface corresponds to the first side, and the second contact surface corresponds to the second side. The first supporting element is configured to be in contact with the first contact surface, the second contact surface, the first side and the second side. When viewed along the main axis, the minimum distance between the center of the first supporting element and the first central line of the first side is greater than the minimum distance between the center of the first stabilizing element and the first central line.

According to some embodiments, when viewed along the main axis, the fixed assembly with a polygonal structure has a third side which is connected to the second side. The optical element driving mechanism further includes a second guiding assembly configured to guide the movable part to move relative to the fixed assembly. The second guiding assembly includes a third stabilizing element which is located on the third side. The second guiding assembly further includes a fourth stabilizing element corresponding to the third stabilizing element. When viewed along the main axis, the movable part has a polygonal structure, corresponding to the fixed assembly.

According to some embodiments, when viewed along the main axis, the movable part has an outward-facing side corresponding to the third side. The fourth stabilizing element is disposed on the outward-facing side. The third stabilizing element and the fourth stabilizing element are magnetic elements. A second stabilizing force is generated between the third stabilizing element and the fourth stabilizing element and is configured to push the movable part along the first axis. The second stabilizing force is a magnetic repulsion force. The second stabilizing force is not perpendicular to the first stabilizing force.

According to some embodiments, when viewed along the main axis, the minimum distance between the center of the first supporting element and the first central line of the first side is greater than the minimum distance between the center of the first stabilizing element and the first central line. The optical element driving mechanism further includes a second guiding assembly configured to guide the movable part to move relative to the fixed assembly. The second guiding assembly includes a second supporting element, a second corresponding element and a second contact portion. The first stabilizing force is configured to drive the movable part toward the second supporting element. The second corresponding element has a second accommodating space configured to accommodate at least a portion of the second supporting element. The second contact portion is located on the second corresponding element and is in contact with the second supporting element. The second corresponding element and the first corresponding element have different structures. The second contact portion and the first contact portion have different structures.

According to some embodiments, the first contact portion has a first contact surface and a second contact surface. The first contact surface and the second contact surface are configured to be in contact with the first supporting element. The first contact surface is connected to the second contact surface. The first contact surface is not parallel to the second contact surface. When viewed along the main axis, the first contact surface and the second contact surface form a V-shaped structure.

According to some embodiments, the second contact portion has a third contact surface, a fourth contact surface and a fifth contact surface. The third contact surface, the fourth contact surface and the fifth contact surface are configured to be in contact with the second supporting element. The fourth contact surface is connected between the third contact surface and the fifth contact surface. The third contact surface is not parallel to the fourth contact surface. The third contact surface is parallel to the fifth contact surface. When viewed along the main axis, the third contact surface, the fourth contact surface and the fifth contact surface form a half rectangular structure.

According to some embodiments, when viewed along the main axis, the first corresponding element and the second corresponding element respectively have a first open structure and a second open structure. When viewed along the main axis, an opening direction of the first open structure is different from an opening direction of the second open structure. When viewed along the main axis, the opening direction of the first open structure is not parallel to the opening direction of the second open structure.

According to some embodiments, when viewed along the main axis, the second supporting element is located on the second side. When viewed along the main axis, the minimum distance between the center of the second supporting element and the second central line of the second side is different from the minimum distance between the center of the first supporting element and the first central line. When viewed along the main axis, the minimum distance between the center of the second supporting element and the second central line is less than the minimum distance between the center of the first supporting element and the first central line.

According to some embodiments, the driving assembly includes a transmission element which extends along the main axis. When viewed along the main axis, the distance between the center of the transmission element and the center of the first supporting element is different from the distance between the center of the transmission element and the center of the second supporting element. When viewed along the main axis, the distance between the center of the transmission element and the center of the first supporting element is greater than the distance between the center of the transmission element and the center of the second supporting element.

According to some embodiments, the driving assembly includes a driving source, a transmission element, a collaborative element and a clamping member. The collaborative element corresponds to the driving source and generates a driving force with the driving source. The transmission element is configured to transmit the driving force. The clamping member corresponds to the transmission element. When viewed along the main axis, a center connection line, which connects the center of the first supporting element to the center of the transmission element, passes through the optical element. When viewed along the second axis, the movable part has at least one supporting portion which extends toward the transmission element along the first axis. The second axis is perpendicular to the first axis. The supporting portion is configured to support the transmission element when the movable part moves.

According to some embodiments, the fixed assembly has a first surface which faces the movable part. The movable part has a second surface which faces the first surface. The first surface is not parallel to the second surface. The first surface is not perpendicular to the second surface.

According to some embodiments, when viewed along the main axis, the angle between the first surface and the second surface is less than 5 degrees. When viewed along the main axis, the first surface and the second surface are both located on the first side. The first stabilizing force is applied to the movable part and generates a first torque around the transmission element which serves as a rotating axis. The first torque causes the second surface to move closer to the first surface.

According to some embodiments, the optical element driving mechanism further includes a position sensing assembly configured to sense the motion of the movable part. The second stabilizing element is disposed on the movable part. The position sensing assembly corresponds to the second stabilizing element. The second stabilizing element has a magnetic material. The position sensing assembly includes a sensor configured to sense changes in the magnetic field of the second stabilizing element. The sensor is disposed on the fixed assembly. When viewed along a second axis, the sensor and the second stabilizing element are arranged along the main axis. The second axis is perpendicular to the first axis.

According to some embodiments, the optical element driving mechanism further includes a protective element which is disposed on the fixed assembly. The protective element has a columnar structure which extends along the main axis. The protective element is configured to pass through the movable part. When viewed along the main axis, a first quadrant, a second quadrant, a third quadrant and a fourth quadrant are defined when the main axis serves as the origin. When viewed along the main axis, the protective element and the transmission element are located in the fourth quadrant.

The present disclosure provides an optical element driving mechanism which includes a fixed assembly, a movable part, and a driving assembly. The movable part is movable relative to the fixed assembly, and the driving assembly is configured to drive the movable part to move relative to the fixed assembly. The optical element driving mechanism further includes at least one guiding assembly configured to guide the movement of the movable part to prevent the movable part from tilting during movement, thereby causing unclear images.

In some embodiments, the first guiding assembly may be disposed at the first corner of the fixed assembly, and the first guiding assembly may include a first supporting element, a first stabilizing element, and a second stabilizing element. The first supporting element may, for example, be a rolling ball, and is disposed between the movable part and the fixed assembly, and the first stabilizing element and the second stabilizing element generate a first stabilizing force, which is applied to the movable part to drive the movable part to be close to the first supporting element, thereby preventing the movable part from tilting during movement.

In addition, when viewed along the main axis, the movable part may have a rectangular structure, and the first guiding assembly and the driving assembly are located at two opposite corners of the movable part. Based on such a structural configuration, the movable part can move more stable, and it can also avoid the problem that the transmission element of the driving assembly is broken by the movable part when the optical element driving mechanism is impacted.

Additional features and advantages of the disclosure will be set forth in the description which follows, and, in part, will be obvious from the description, or can be learned by practice of the principles disclosed herein. The features and advantages of the disclosure can be realized and obtained by means of the instruments and combinations pointed out in the appended claims. These and other features of the disclosure will become more fully apparent from the following description and appended claims, or can be learned by the practice of the principles set forth herein.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of an optical element driving mechanism 100 according to an embodiment of the present disclosure.

FIG. 2 is an exploded diagram of the optical element driving mechanism 100 according to an embodiment of the present disclosure.

FIG. 3 is a cross-sectional view of the optical element driving mechanism 100 along line A-A in FIG. 1 according to an embodiment of the present disclosure.

FIG. 4 is a cross-sectional view of the optical element driving mechanism 100 along line B-B in FIG. 1 according to an embodiment of the present disclosure.

FIG. 5 is a cross-sectional view of the optical element driving mechanism 100 along line C-C in FIG. 1 according to an embodiment of the present disclosure.

FIG. 6 is a cross-sectional view of the optical element driving mechanism 100 along line B-B in FIG. 1 according to another embodiment of the present disclosure.

FIG. 7 is a cross-sectional view of the optical element driving mechanism 100 along line B-B in FIG. 1 according to another embodiment of the present disclosure.

FIG. 8 is a cross-sectional view of the optical element driving mechanism 100 along line B-B in FIG. 1 according to another embodiment of the present disclosure.

FIG. 9 is a cross-sectional view of the optical element driving mechanism 100 along line D-D in FIG. 1 according to another embodiment of the present disclosure.

FIG. 10 is a cross-sectional view of the optical element driving mechanism 100 along line A-A in FIG. 1 according to another embodiment of the present disclosure.

### DETAILED DESCRIPTION OF THE INVENTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are in direct contact, and may also include embodiments in which additional features may be disposed between the first and second features, such that the first and second features may not be in direct contact.

In addition, the present disclosure may repeat reference numerals and/or letters in the various examples. This repetition is for the purpose of simplicity and clarity and does not in itself dictate a relationship between the various embodiments and/or configurations discussed. Moreover, the formation of a feature on, connected to, and/or coupled to another feature in the present disclosure that follows may include embodiments in which the features are in direct contact, and may also include embodiments in which additional features may be disposed interposing the features, such that the features may not be in direct contact. In addition, spatially relative terms, for example, “vertical,” “above,” “over,” “below,”, “bottom,” etc. as well as derivatives thereof (e.g., “downwardly,” “upwardly,” etc.) are used in the present disclosure for ease of description of one feature's relationship to another feature. The spatially relative terms are intended to cover different orientations of the device, including the features.

Unless defined otherwise, all technical and scientific terms used herein have the same meaning as commonly understood by one of ordinary skill in the art to which this disclosure belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

Use of ordinal terms such as “first”, “second”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

In addition, in some embodiments of the present disclosure, terms concerning attachments, coupling and the like, such as “connected” and “interconnected”, refer to a relationship wherein structures are secured or attached to one another either directly or indirectly through intervening structures, as well as both movable or rigid attachments or relationships, unless expressly described otherwise.

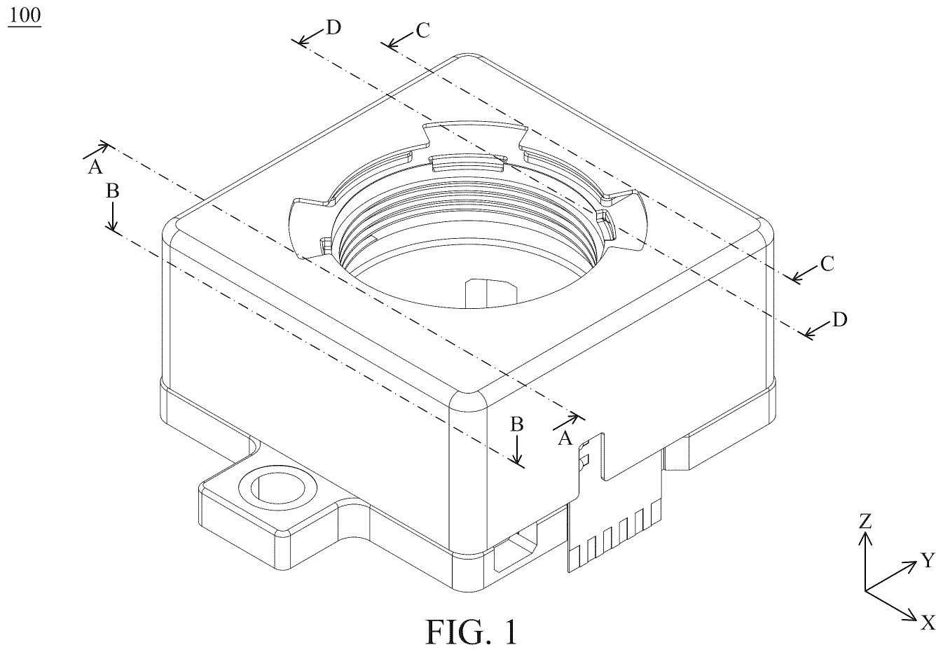

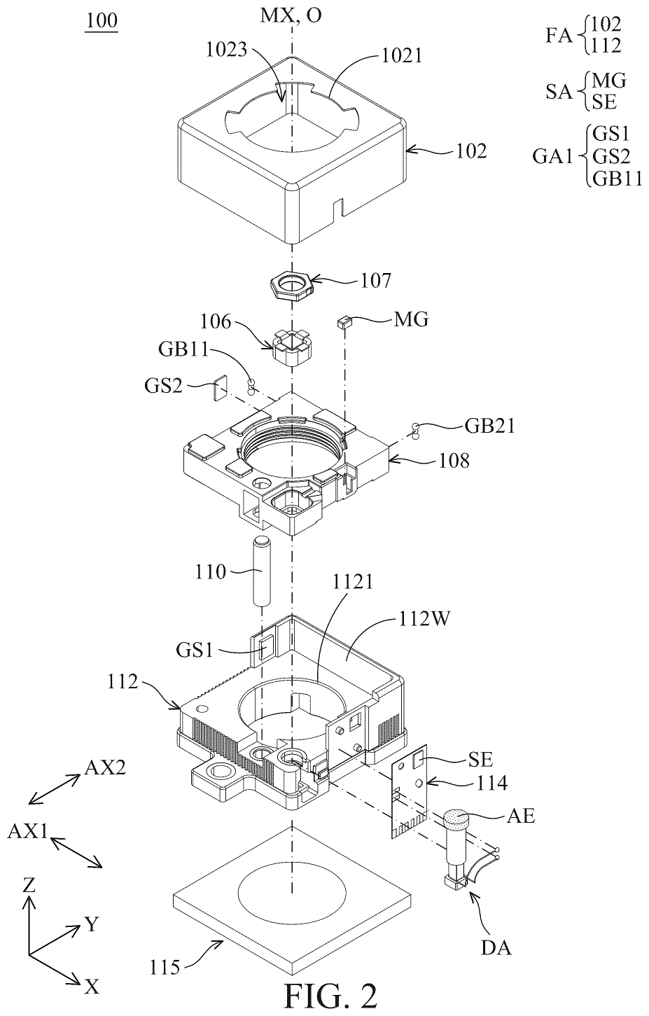

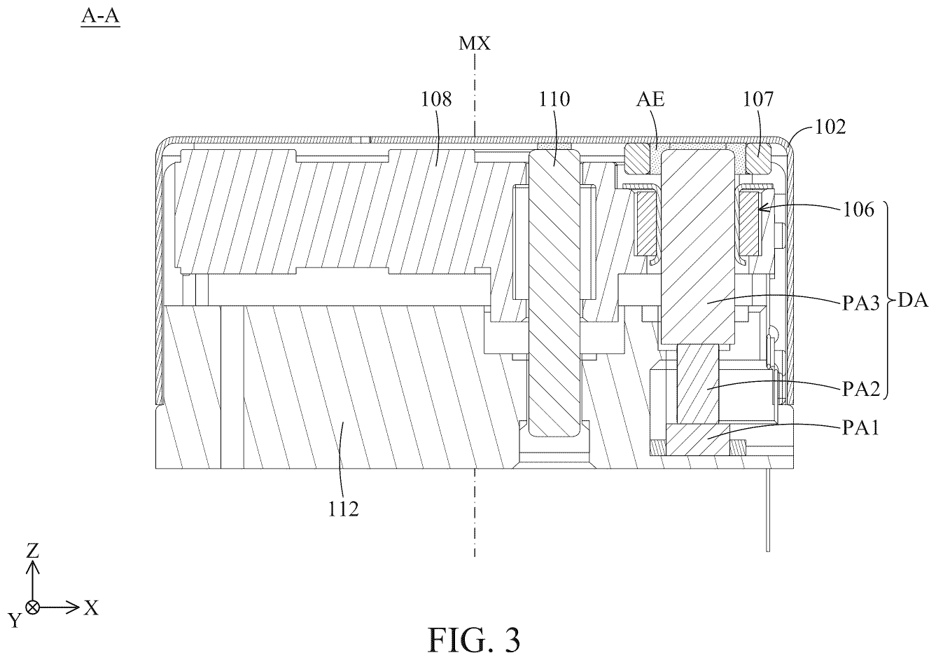

Please refer to FIG. 1 to FIG. 3. FIG. 1 is a schematic diagram of an optical element driving mechanism 100 according to an embodiment of the present disclosure, FIG. 2 is an exploded diagram of the optical element driving mechanism 100 according to an embodiment of the present disclosure, and FIG. 3 is a cross-sectional view of the optical element driving mechanism 100 along line A-A in FIG. 1 according to an embodiment of the present disclosure. The optical element driving mechanism 100 can be an optical camera system and can be configured to hold and drive an optical element (such a camera lens, not shown in figures). The optical element driving mechanism 100 can be installed in various electronic devices or portable electronic devices, such as a smartphone, for allowing a user to perform the image capturing function. In this embodiment, the optical element driving mechanism 100 can be with an auto-focusing (AF) function, but it is not limited thereto. In other embodiments, the optical element driving mechanism 100 can also perform the functions of auto-focusing and optical image stabilization (OIS).

In this embodiment, the optical element driving mechanism 100 may include a fixed assembly FA, a movable part 108, a driving assembly DA and a first guiding assembly GA1. The movable part 108 is configured to hold the aforementioned optical element (such as an optical lens, not shown in the figures), and the movable part 108 is movable relative to the fixed assembly FA. The driving assembly DA is configured to drive the movable part 108 to move relative to the fixed assembly FA, and the first guiding assembly GA1 is configured to guide the movable part 108 to move relative to the fixed assembly FA.

In this embodiment, as shown in FIG. 2, the fixed assembly FA includes a casing 102 and a base 112. The casing 102 has a hollow structure, and a casing opening 1021 is formed on it. A base opening 1121 is formed on the base 112, the center of the casing opening 1021 corresponds to an optical axis O of the optical element, and the base opening 1121 corresponds to a photosensitive assembly 115 which is disposed below the base 112. External light can enter the casing 102 through the casing opening 1021 and to be received by the aforementioned photosensitive assembly 115 after passing through the optical element and the base opening 1121 so as to generate a digital image signal. The photosensitive assembly 115 may, for example, be an image sensor, but it is not limited thereto.

Furthermore, the casing 102 and the base 112 are arranged along a main axis MX, and the casing 102 is disposed on the base 112. The main axis MX can overlap or be parallel to the optical axis O. The casing 102 may have an accommodation space 1023 for accommodating components such as the movable part 108 and the driving assembly DA, and so on.

For example, the optical element driving mechanism 100 may further include a circuit assembly 114 which is fixedly disposed a side wall 112W of the base 112, and a portion of the circuit assembly 114 is accommodated in the accommodation space 1023. The circuit assembly 114 may, for example, be a flexible circuit board, but it is not limited thereto.

In this embodiment, as shown in FIG. 2 and FIG. 3, the driving assembly DA is electrically connected to the circuit assembly 114 and may include a collaborative element PA1, a driving source PA2, a transmission element PA3 and a clamping member 106. The transmission element PA3 may have a columnar structure which extends along the main axis MX, and the transmission element PA3 may be made of carbon material, but they are not limited thereto.

The collaborative element PA1 can be, for example, a counterweight, but it is not limited thereto. In other embodiments, the collaborative element PA1 can be a spring sheet. The driving source PA2 may, for example, be a piezoelectric element, fixedly connected between the collaborative element PA1 and the transmission element PA3. In this embodiment, the driving source PA2 is made of a ceramic material, but it is not limited thereto.

Furthermore, the clamping member 106 corresponds to transmission element PA3. Specifically, as shown in FIG. 3, the transmission element PA3 passes through the movable part 108, and the movable part 108 clamps the transmission element PA3 through the clamping member 106. The clamping member 106 may, for example, be metal spring sheets, rubber or a combination thereof, but it is not limited thereto.

Next, the collaborative element PA1 corresponds to the driving source PA2 and generates a driving force with the driving source PA2, and the transmission element PA3 is configured to transmit the driving force to the movable part 108 so as to drive the movable part 108 to move along the main axis MX to achieve the purpose of autofocus.

In addition, the optical element driving mechanism 100 may further include a connecting member 107 configured to connect the driving assembly DA to the fixed assembly FA. Specifically, as shown in FIG. 3, the connecting member 107 is fixedly disposed on the inner side of the casing 102, and the connecting member 107 is connected to the transmission element PA3 through an adhesive element AE. The adhesive element AE may, for example, be elastic glue, but it is not limited thereto.

Furthermore, the optical element driving mechanism 100 may further include a position sensing assembly SA configured to sense the movement of the movable part 108. The position sensing assembly SA may include a sensing magnet MG and a sensor SE. The sensing magnet MG is fixedly disposed on the movable part 108, and the sensor SE is disposed on the circuit assembly 114. The sensor SE may be a Hall sensor, for example, and the sensing magnet MG may be a multipole magnet, for example, but they are not limited thereto.

As shown in FIG. 2 and FIG. 3, because the center of gravity of the movable part 108 may be biased to the left side, when the driving assembly DA drives the movable part 108 to move along the main axis MX, the movable part 108 may tilt, thereby causing a problem wherein the image is unclear. In order to prevent unclear images, the present disclosure provides the aforementioned first guiding assembly GA1 to avoid the problem of the movable part 108 tilting during movement. The specific structure and configuration of the first guiding assembly GAL are described in detail below.

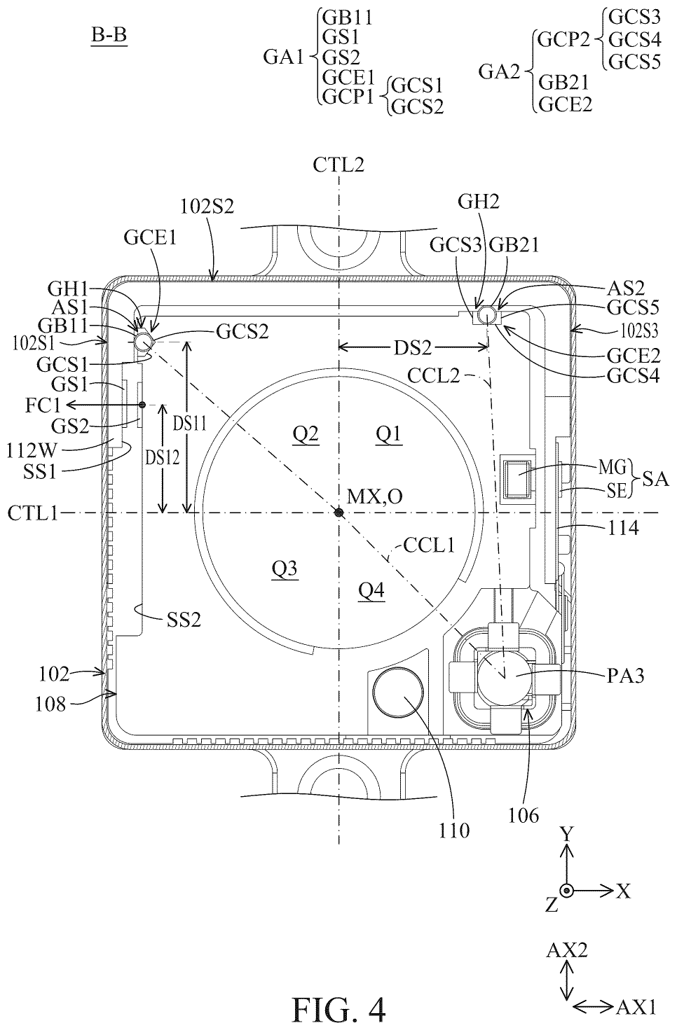

Please refer to FIG. 1 to FIG. 4. FIG. 4 is a cross-sectional view of the optical element driving mechanism 100 along line B-B in FIG. 1 according to an embodiment of the present disclosure. As shown in FIG. 4, the first guiding assembly GA1 may include a first stabilizing element GS1, a second stabilizing element GS2, at least one supporting element (a first supporting element GB11), a first corresponding element GCE1 and a first contact portion GCP1.

The first supporting element GB11 and the first corresponding element GCE1 are arranged along a first axis AX1, and the first stabilizing element GS1 is configured to generate a first stabilizing force FC1 onto the movable part 108. The first stabilizing element GS1 may, for example, be a magnet, which is fixedly disposed on the side wall 112W of the base 112 of the fixed assembly FA, and the second stabilizing element GS2 can be a magnetic conductive element, such as a magnetic conductive plate, which is fixedly disposed on the movable part 108. The setting position of the first stabilizing element GS1 is not limited to being set on the base 112. In other embodiments, the first stabilizing element GS1 can be disposed on the casing 102.

The aforementioned first stabilizing force FC1 is generated between the first stabilizing element GS1 and the second stabilizing element GS2 to drive the movable part 108 toward the first supporting element GB11. In this embodiment, the first stabilizing force FC1 is magnetic attraction force, but it is not limited thereto. The first stabilizing element GS1 can be one of a magnetic permeable element and a magnetic element, and the second stabilizing element GS2 can be the other one of the magnetic permeable element and the magnetic element. For example, the first stabilizing element GS1 may, for example, be a magnet, and the second stabilizing element GS2 may, for example, be a magnetic permeable plate, but they are not limited thereto, and they are interchangeable.

In this embodiment, the first supporting element GB11 is a rolling ball, but it is not limited thereto. Furthermore, the first corresponding element GCE1 is a portion of the movable part 108 and is configured to accommodate the first supporting element GB11. For example, the first corresponding element GCE1 may have a first accommodating space AS1 configured to accommodate at least a portion of the first supporting element GB11. In addition, the first contact portion GCP1 is located on the first corresponding element GCE1 and is in contact with the first supporting element GB11.

The first contact portion GCP1 has a first contact surface GCS1 and a second contact surface GCS2, and the first contact surface GCS1 and the second contact surface GCS2 are configured to contact the first supporting element GB11.

As shown in FIG. 4, the first contact surface GCS1 and the second contact surface GCS2 may be inclined surfaces, and the first contact surface GCS1 is connected to the second contact surface GCS2, and the first contact surface GCS1 is not parallel to the second contact surface GCS2. When viewed along the main axis MX, the first contact surface GCS1 and the second contact surface GCS2 may form a V-shaped structure.

Furthermore, when viewed along the main axis MX, the fixed assembly FA with a polygonal structure has a first side 102S1 and a second side 102S2. When viewed along main axis MX, the first supporting element GB11 is located on first side 102S1, and when viewed along main axis MX, the first stabilizing element GS1 is located on first side 102S1.

When viewed along the main axis MX, the distance DS11 between the center of the first supporting element GB11 and the first central line CTL1 of the first side 102S1 is different from the distance DS12 between the center of the first stabilizing element GS1 and the first central line CTL1.

As shown in FIG. 4, the distance DS11 between the center of the first supporting element GB11 and the first central line CTL1 along a second axis AX2 is greater than the distance DS12 between the center of the first stabilizing element GS1 and the first central line CTL1 along the second axis AX2. The second axis AX2 is perpendicular to the first axis AX1.

In addition, when viewed along the main axis MX, the center connection line CCL1 which connects the center of the first supporting element GB11 to the center of the transmission element PA3 passes through the optical element (located in the circular hollow part of the movable part 108). Such a configuration can make the movable part 108 more stable during movement.

Furthermore, it is worth mentioning that only a single first guiding assembly GA1 is disposed on the first side 102S1 of the optical element driving mechanism 100. That is, except for the first guiding assembly GA1, there is no other guiding assembly on the first side 102S1.

Similarly, the optical element driving mechanism 100 may further include a second guiding assembly GA2 configured to guide the movable part 108 to move relative to the fixed assembly FA. The second guiding assembly GA2 may include a second supporting element GB21, a second corresponding element GCE2 and a second contact portion GCP2.

The second supporting element GB21 may, for example, be a rolling ball, and the second corresponding element GCE2 is also a part of the movable part 108 and may have a second accommodating space AS2 configured to accommodate at least a portion of the second supporting element GB21. Furthermore, the second contact portion GCP2 is located on the second corresponding element GCE2 and is in contact with the second supporting element GB21.

As shown in FIG. 4, in addition to contacting the second contact portion GCP2, the second supporting element GB21 is also configured to contact the side wall 112W of the base 112 of the fixed assembly FA, and the aforementioned first stabilizing force FC1 can drive the movable part 108 to move toward the second supporting element GB21.

It is worth noting that the second corresponding element GCE2 and the first corresponding element GCE1 have different structures. That is, the second contact portion GCP2 and the first contact portion GCP1 may have different structures.

For example, in this embodiment, the second contact portion GCP2 has a third contact surface GCS3, a fourth contact surface GCS4 and a fifth contact surface GCS5, and the third contact surface GCS3, the fourth contact surface GCS4 and the fifth contact surface GCS5 are configured to be in contact with the second supporting element GB21.

The fourth contact surface GCS4 is connected between the third contact surface GCS3 and the fifth contact surface GCS5. The third contact surface GCS3 may not be parallel to the fourth contact surface GCS4, and the third contact surface GCS3 may be parallel to the fifth contact surface GCS5.

When viewed along the main axis MX, the third contact surface GCS3, the fourth contact surface GCS4 and the fifth contact surface GCS5 form a half rectangular structure, which is different from the V-shaped structure which is formed by the first contact surface GCS1 and the second contact surface GCS2.

Furthermore, when viewed along the main axis MX, the first corresponding element GCE1 and the second corresponding element GCE2 may respectively have a first open structure GH1 and a second open structure GH2, and the opening direction of the first open structure GH1 is different from the opening direction of the second open structure GH2.

As shown in FIG. 4, the first open structure GH1 is oriented in the −X-axis direction, and the second open structure GH2 is oriented in the +Y-axis direction. That is, the opening direction of the first open structure GH1 is not parallel to the opening direction of the second open structure GH2.

It should be noted that although two guiding assemblies are provided in this embodiment, in other embodiments, the optical element driving mechanism 100 may only include one single guiding assembly, such as only includes the first guiding assembly GA1.

Furthermore, as shown in FIG. 4, when viewed along the main axis MX, the second supporting element GB21 is located on the second side 102S2. When viewed along the main axis MX, the distance DS2 between the center of the second supporting element GB21 and the second central line CTL2 of the second side 102S2 is different from the distance DS11 between the center of the first supporting element GB11 and the first central line CTL1.

Specifically, when viewed along the main axis MX, the distance DS2 between the center of the second supporting element GB21 and the second central line CTL2 along the first axis AX1 is less than the distance DS11 between the center of the first supporting element GB11 and the first central line CTL1.

When viewed along the main axis MX, the distance between the center of the transmission element PA3 and the center of the first supporting element GB11 is different from the distance between the center of the transmission element PA3 and the center of the second supporting element GB21.

For example, when viewed along the main axis MX, the distance between the center of the transmission element PA3 and the center of the first supporting element GB11 (that is, the length of the center connection line CCL1) is greater than the distance between the center of the transmission element PA3 and the center of the second supporting element GB21 (that is, the length of the center connection line CCL2).

Furthermore, as shown in FIG. 4, the base 112 of the fixed assembly FA has a first surface SS1 which face toward the movable part 108, and the movable part 108 has a second surface SS2 which face toward the first surface SS1. When the first stabilizing force FC1 is applied to the movable part 108, the first surface SS1 may not be parallel to the second surface SS2, and the first surface SS1 may not be perpendicular to the second surface SS2.

For example, when viewed along the main axis MX, the angle between the first surface SS1 and the second surface SS2 is less than 5 degrees, and when viewed along the main axis MX, the first surface SS1 and the second surface SS2 are both located on the first side 102S1.

It is worth mentioning that when the first stabilizing force FC1 is applied to the movable part 108, a first torque is generated around the transmission element PA3, which serves as a rotating axis (or a pivot point), and this first torque causes the second surface SS2 to move closer to the first surface SS1. Based on this configuration, the first guiding assembly GAL and the second guiding assembly GA2 can smoothly guide the movement of the movable part 108 without any tilt problem.

Next, please refer to FIG. 2 to FIG. 4. In this embodiment, the optical element driving mechanism 100 may further include a protective element 110 which is disposed on the base 112 of the fixed assembly FA. The protective element 110 can be made of metal material and has a columnar structure which extends along the main axis MX, and the protective element 110 passes through the movable part 108.

As shown in FIG. 3 and FIG. 4, the protective element 110 is arranged adjacent to the transmission element PA3. Specifically, as shown in FIG. 4, when viewed along the main axis MX, with the main axis MX as the origin, a first quadrant Q1, a second quadrant Q2, a third quadrant Q3 and a fourth quadrant Q4 can be defined, and the protective element 110 and the transmission element PA3 are located in fourth quadrant Q4.

Based on the structural design and position configuration of the protective element 110, the problem that the movable part 108 breaks the transmission element PA3 when the optical element driving mechanism 100 is impacted can be avoided. That is, the protective element 110 can absorb the impact force of the movable part 108 to protect the transmission element PA3.

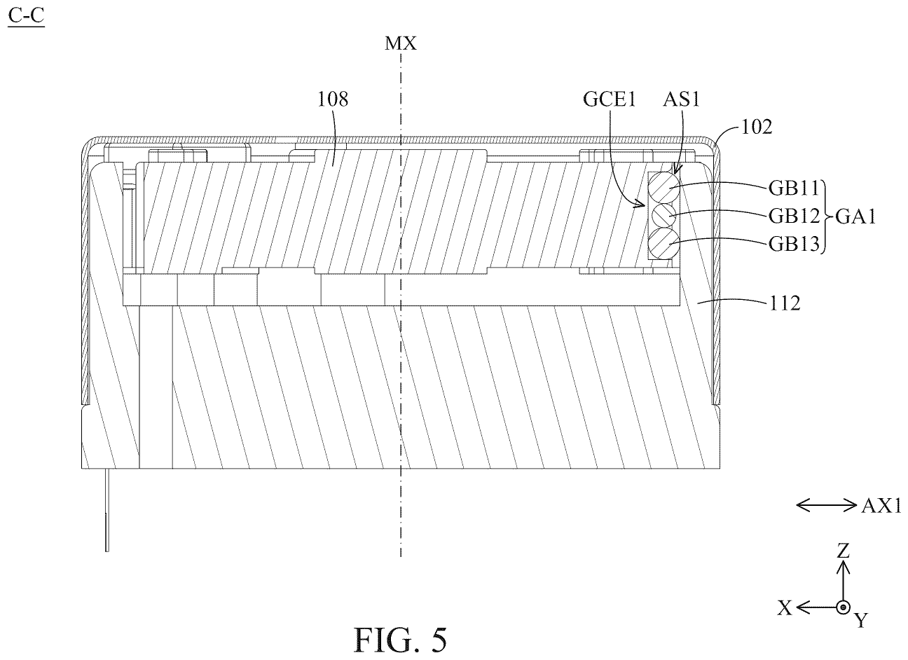

Next, please refer to FIG. 2 and FIG. 5. FIG. 5 is a cross-sectional view of the optical element driving mechanism 100 along line C-C in FIG. 1 according to an embodiment of the present disclosure. In this embodiment, the first guiding assembly GA1 may further include a plurality of first supporting elements GB11, GB12, and GB13, which are disposed in the first accommodating space AS1. These first supporting elements GB11, GB12, and GB13 are arranged along the main axis MX in sequence.

It is worth noting that the sizes of the first supporting elements GB11, GB12, and GB13 may be different. In this embodiment, the sizes of the first supporting elements GB11 and GB13 may be the same, and the size of the first supporting element GB12 is smaller than the size of the first supporting elements GB11 and GB13. Based on this design, it can avoid the situation that the movable part 108 is stuck and cannot move smoothly due to tolerance issues.

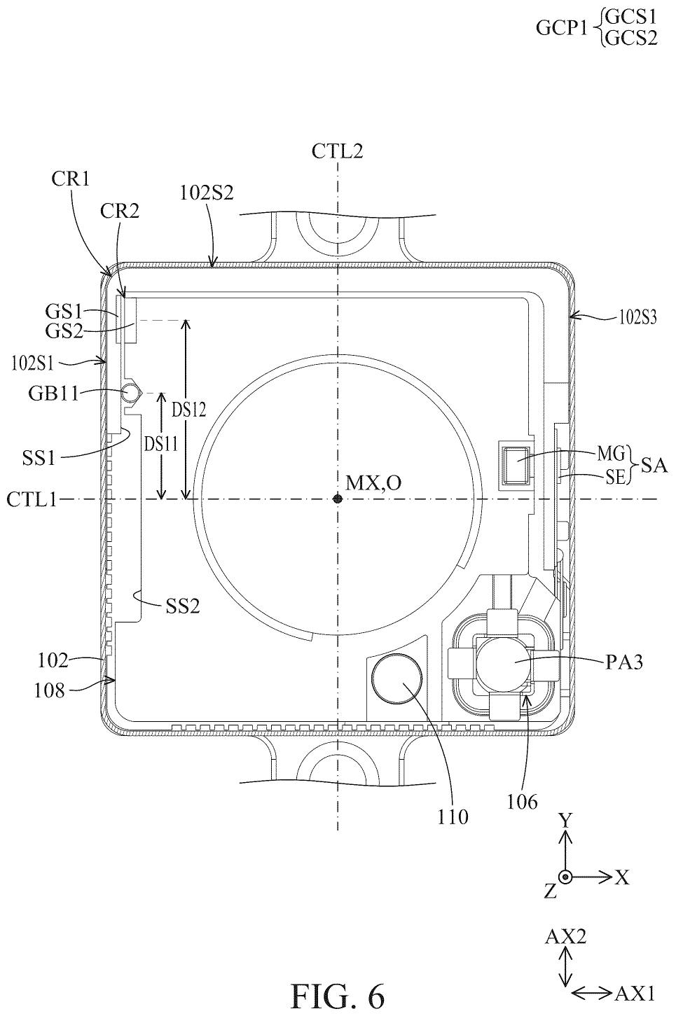

Next, please refer to FIG. 6, which is a cross-sectional view of the optical element driving mechanism 100 along line B-B in FIG. 1 according to another embodiment of the present disclosure. In this embodiment, when viewed along the main axis MX, the movable part 108 has a polygonal structure, corresponding to the fixed assembly FA. For example, the movable part 108 has a generally rectangular structure, corresponding to the base 112 which has a rectangular structure.

When viewed along the main axis MX, the base 112 of the fixed assembly FA has a first corner CR1, and when viewed along the main axis MX, the first corner CR1 is located between the first side 102S1 and the second side 102S2.

Similarly, when viewed along the main axis MX, the movable part 108 may have a second corner CR2, corresponding to the first corner CR1, and the second corner CR2 is also located between the first side 102S1 and the second side 102S2.

As shown in FIG. 6, in this embodiment, the first supporting element GB11 is not disposed at the first corner CR1. On the contrary, the second stabilizing element GS2 is disposed at the second corner CR2, and the first stabilizing element GS1 is disposed on the base 112 correspondingly.

Similar to the previous embodiment, in this embodiment, the first stabilizing element GS1 can be a magnet, for example, and the second stabilizing element GS2 can be a magnetic permeable plate, for example, but they are not limited thereto.

As shown in FIG. 6, when viewed along the main axis MX, the distance DS11 between the center of the first supporting element GB11 and the first central line CTL1 of the first side 102S1 is less than the distance DS12 between the center of the first stabilizing element GS1 and the first central line CTL1. Based on this configuration, the stabilizing force generated by the first stabilizing element GS1 and the second stabilizing element GS2 is greater, which can make the movable part 108 more stable during movement.

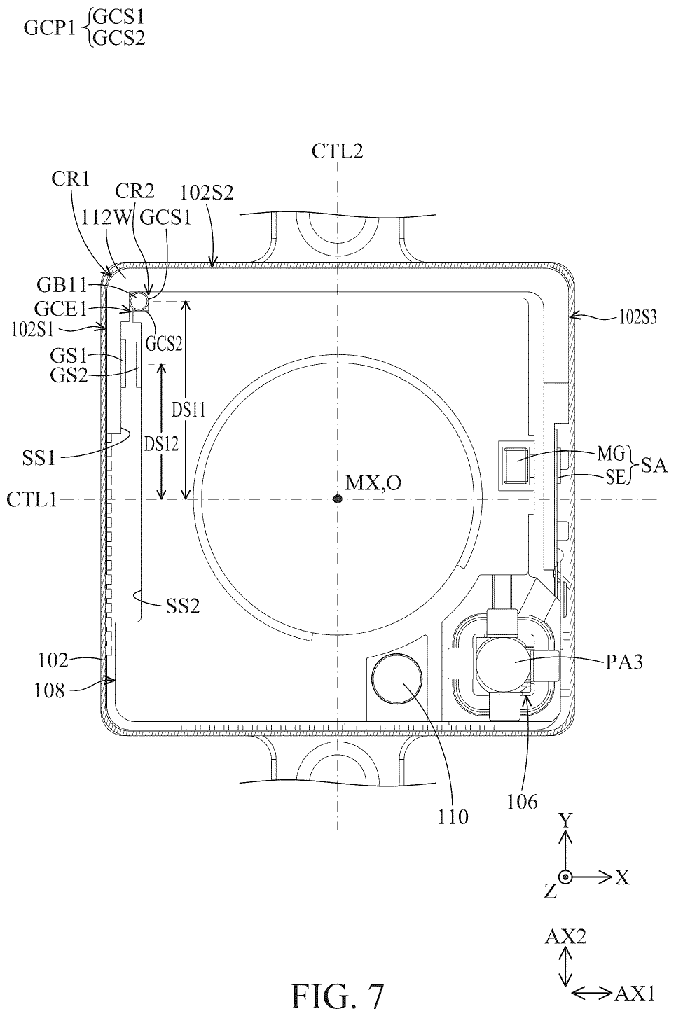

Next, please refer to FIG. 7, which is a cross-sectional view of the optical element driving mechanism 100 along line B-B in FIG. 1 according to another embodiment of the present disclosure. In this embodiment, the first supporting element GB11, the first corresponding element GCE1 and the first contact portion GCP1 are located at the second corner CR2, and the first supporting element GB11 is also located at the first corner CR1.

Similarly, the first contact portion GCP1 has a first contact surface GCS1 and a second contact surface GCS2. The first contact surface GCS1 is connected to the second contact surface GCS2, and the first contact surface GCS1 and the second contact surface GCS2 are configured to be in contact with the first supporting element GB11.

The first contact surface GCS1 corresponds to the first side 102S1, and the second contact surface GCS2 corresponds to the second side 102S2. For example, the first contact surface GCS1 may be parallel to the first side 102S1, and the second contact surface GCS2 may be parallel to the second side 102S2, but they are not limited thereto.

As shown in FIG. 7, the first supporting element GB11 is configured to be in contact with the first contact surface GCS1, the second contact surface GCS2, a portion of the base 112 at the first side 102S1 and a portion of the base 112 at the second side 102S2.

When viewed along the main axis MX, the distance DS11 between the center of the first supporting element GB11 and the first central line CTL1 of the first side 102S1 is greater than the distance DS12 between the center of the first stabilizing element GS1 and the first central line CTL1.

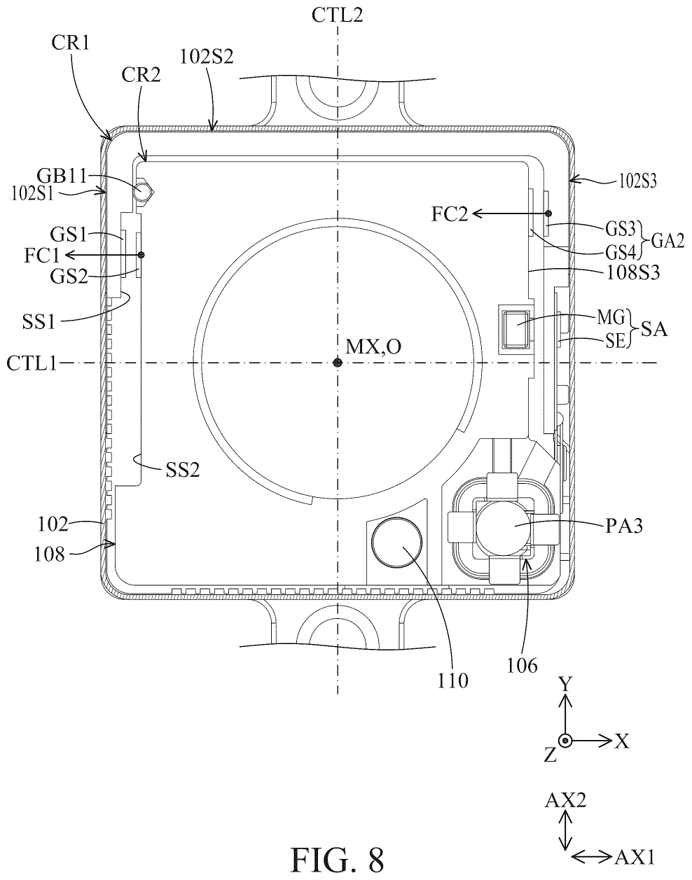

Next, please refer to FIG. 8, which is a cross-sectional view of the optical element driving mechanism 100 along line B-B in FIG. 1 according to another embodiment of the present disclosure. In this embodiment, when viewed along the main axis MX, the fixed assembly FA with a polygonal structure has a third side 102S3 which is connected to the second side 102S2.

Furthermore, in this embodiment, the optical element driving mechanism 100 may further include a second guiding assembly GA2 configured to guide the movable part 108 to move relative to the fixed assembly FA. The second guiding assembly GA2 may include a third stabilizing element GS3 which is located on the third side 102S3, and the second guiding assembly GA2 may further include a fourth stabilizing element GS4 corresponding to the third stabilizing element GS3.

Similarly, when viewed along the main axis MX, the movable part 108 has a polygonal structure, corresponding to the fixed assembly FA. In this embodiment, when viewed along the main axis MX, the movable part 108 has an outward-facing side 108S3 corresponding to the third side 102S3, and the fourth stabilizing element GS4 is fixedly disposed on the outward-facing side 108S3.

In this embodiment, the third stabilizing element GS3 and the fourth stabilizing element GS4 can be magnetic elements, such as magnets, but they are not limited thereto. A second stabilizing force FC2 can be generated between the third stabilizing element GS3 and the fourth stabilizing element GS4, configured to push the movable part 108 along the first axis AX1. The second stabilizing force FC2 is a magnetic repulsion force.

The second stabilizing force FC2 is not perpendicular to the first stabilizing force FC1. For example, the second stabilizing force FC2 may be parallel to the first stabilizing force FC1. Based on the above components and structural configuration, the stability of the movable part 108 during movement can be increased, and the movable part 108 can be prevented from tilting during movement.

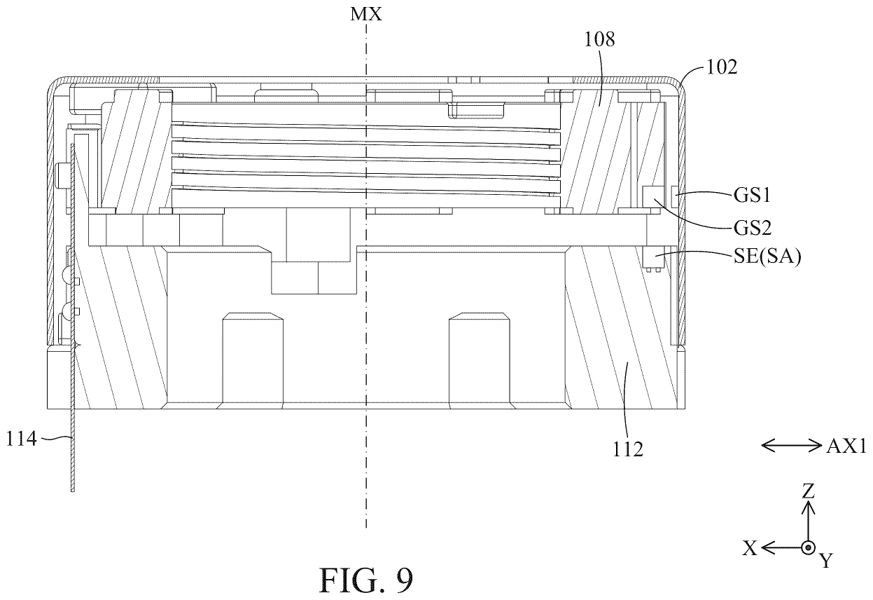

Next, please refer to FIG. 9, which is a cross-sectional view of the optical element driving mechanism 100 along line D-D in FIG. 1 according to another embodiment of the present disclosure. In this embodiment, the position sensing assembly SA is configured to sense the motion of the movable part 108, and the position sensing assembly SA corresponds to the second stabilizing element GS2.

The second stabilizing element GS2 is disposed on the movable part 108, and the second stabilizing element GS2 has magnetic material. For example, in this embodiment, the second stabilizing element GS2 is a magnet, and the first stabilizing element GS1 is a magnetic permeable plate, but they are not limited thereto. For example, the setting positions of the first stabilizing element GS1 and the second stabilizing element GS2 are interchangeable.

Similarly, the position sensing assembly SA may include a sensor SE configured to sense the changes in the magnetic field of the second stabilizing element GS2, and the sensor SE is disposed on the base 112 of the fixed assembly FA. The sensor SE may be, for example, a Hall sensor or a tunnel magneto resistance sensor (TMR sensor), but it is not limited thereto.

As shown in FIG. 9, when viewed along the second axis AX2 (the Y-axis), the sensor SE and the second stabilizing element GS2 are arranged along the main axis MX, and the sensor SE is aligned with the second stabilizing element GS2. Based on the configuration of this embodiment, the sensor SE and the first stabilizing element GS1 can share the magnet (the second stabilizing element GS2) without the need to additionally set up the aforementioned sensing magnet MG. Therefore, the production cost can be reduced and miniaturization can be achieved.

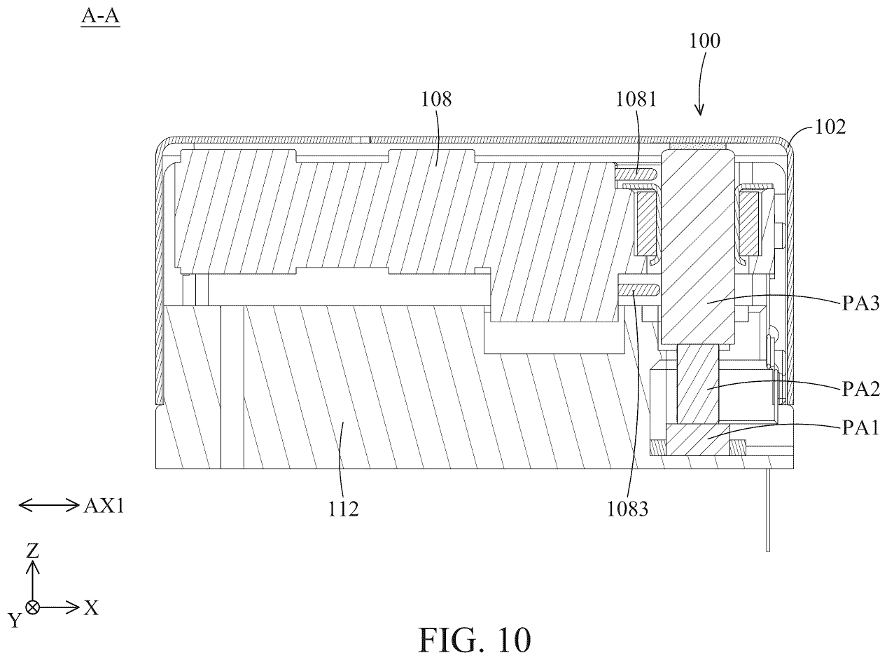

Next, please refer to FIG. 10, which is a cross-sectional view of the optical element driving mechanism 100 along line A-A in FIG. 1 according to another embodiment of the present disclosure. Compared with the previous embodiments, the optical element driving mechanism 100 in this embodiment does not provide the protective element 110. In contrast, as shown in FIG. 10, when viewed along the second axis AX2 (the Y-axis), the movable part 108 may have two support portions 1081 and 1083 extending along the first axis AX1 toward the transmission element PA3.

The two supporting portions 1081 and 1083 are configured to support the transmission element PA3 when the movable part 108 moves. That is, when the movable part 108 moves and tilts, the supporting parts 1081 and 1083 can contact the transmission element PA3 to prevent the transmission element PA3 from being broken by the movable part 108.

It should be noted that when the movable part 108 does not move, the supporting portions 1081 and 1083 are not in contact with the transmission element PA3. In addition, the lengths of the supporting portions 1081 and 1083 may be different. For example, the length of the supporting portion 1081 may be less than the length of the supporting portion 1083, but it is not limited thereto.

In conclusion, the present disclosure provides an optical element driving mechanism 100 which includes a fixed assembly FA, a movable part 108, and a driving assembly DA. The movable part 108 is movable relative to the fixed assembly FA, and the driving assembly DA is configured to drive the movable part 108 to move relative to the fixed assembly FA. The optical element driving mechanism 100 further includes at least one guiding assembly configured to guide the movement of the movable part 108 to prevent the movable part 108 from tilting during movement, thereby causing unclear images.

In some embodiments, the first guiding assembly GA1 may be disposed at the first corner CR1 of the fixed assembly FA, and the first guiding assembly GA1 may include a first supporting element GB11, a first stabilizing element GS1, and a second stabilizing element GS2. The first supporting element GB11 may, for example, be a rolling ball, and is disposed between the movable part 108 and the fixed assembly FA, and the first stabilizing element GS1 and the second stabilizing element GS2 generate a first stabilizing force FC1, which is applied to the movable part 108 to drive the movable part 108 to be close to the first supporting element GB11, thereby preventing the movable part 108 from tilting during movement.

In addition, when viewed along the main axis MX, the movable part 108 may have a rectangular structure, and the first guiding assembly GA1 and the driving assembly DA are located at two opposite corners of the movable part 108. Based on such a structural configuration, the movable part 108 can move more stable, and it can also avoid the problem that the transmission element PA3 of the driving assembly DA is broken by the movable part 108 when the optical element driving mechanism 100 is impacted.

Although the embodiments and their advantages have been described in detail, it should be understood that various changes, substitutions, and alterations can be made herein without departing from the spirit and scope of the embodiments as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein can be utilized according to the disclosure. Accordingly, the appended claims are intended to include within their scope such processes, machines, manufacture, compositions of matter, means, methods, or steps. In addition, each claim constitutes a separate embodiment, and the combination of various claims and embodiments are within the scope of the disclosure.

What is claimed is:

1. An optical element driving mechanism, comprising:
a fixed assembly, having a main axis;
a movable part, configured to be connected to an optical element, wherein the movable part is movable relative to the fixed assembly; and
a driving assembly, configured to drive the movable part to move relative to the fixed assembly.

2. The optical element driving mechanism as claimed in claim 1, wherein
the optical element driving mechanism further includes a first guiding assembly configured to guide the movable part to move relative to the fixed assembly;
the first guiding assembly includes a first stabilizing element, a first supporting element, a first corresponding element and a first contact portion;
the first supporting element and the first corresponding element are arranged along a first axis;
the first guiding assembly further includes a second stabilizing element corresponding to the first stabilizing element;
the first stabilizing element is configured to generate a first stabilizing force with the second stabilizing element, and the first stabilizing force is applied to the movable part;
the first stabilizing force drives the movable part toward the first supporting element.

3. The optical element driving mechanism as claimed in claim 2, wherein
the first corresponding element has a first accommodating space configured to accommodate at least a portion of the first supporting element;
the first contact portion is located on the first corresponding element and is configured to be in contact with the first supporting element;
when viewed along the main axis, the fixed assembly with a polygonal structure has a first side and a second side;
when viewed along the main axis, the first supporting element is located on the first side;
when viewed along the main axis, the first stabilizing element is located on the first side;
when viewed along the main axis, a minimum distance between a center of the first supporting element and a first central line of the first side is different from a minimum distance between a center of the first stabilizing element and the first central line.

4. The optical element driving mechanism as claimed in claim 3, wherein
when viewed along the main axis, the movable part has a polygonal structure, corresponding to the fixed assembly;
when viewed along the main axis, the fixed assembly has a first corner;
when viewed along the main axis, the first corner is located between the first side and the second side;
when viewed along the main axis, the movable part has a second corner corresponding to the first corner;
the second corner is located between the first side and the second side;
the first supporting element is not disposed at the first corner;
the second stabilizing element is disposed at the second corner.

5. The optical element driving mechanism as claimed in claim 4, wherein
the first stabilizing element includes one of a magnetic permeable element and a magnetic element;
the second stabilizing element includes the other one of the magnetic permeable element and the magnetic element;
when viewed along the main axis, the minimum distance between the center of the first supporting element and the first central line of the first side is less than the minimum distance between the center of the first stabilizing element and the first central line;
the first side is only provided with the first guiding assembly.

6. The optical element driving mechanism as claimed in claim 3, wherein
when viewed along the main axis, the movable part has a polygonal structure, corresponding to the fixed assembly;
when viewed along the main axis, the fixed assembly movable part has a first corner;
when viewed along the main axis, the first corner is located between the first side and the second side;
when viewed along the main axis, the movable part has a second corner corresponding to the first corner;
the second corner is located between the first side and the second side;
the first supporting element, the first corresponding element and the first contact portion are located at the second corner;
the first supporting element is located at the first corner.

7. The optical element driving mechanism as claimed in claim 6, wherein
the first contact portion has a first contact surface and a second contact surface;
the first contact surface is connected to the second contact surface;
the first contact surface and the second contact surface are configured to be in contact with the first supporting element;
the first contact surface corresponds to the first side, and the second contact surface corresponds to the second side;
the first supporting element is configured to be in contact with the first contact surface, the second contact surface, the first side and the second side;
when viewed along the main axis, the minimum distance between the center of the first supporting element and the first central line of the first side is greater than the minimum distance between the center of the first stabilizing element and the first central line.

8. The optical element driving mechanism as claimed in claim 3, wherein
when viewed along the main axis, the fixed assembly with a polygonal structure has a third side which is connected to the second side;
the optical element driving mechanism further includes a second guiding assembly configured to guide the movable part to move relative to the fixed assembly;
the second guiding assembly includes a third stabilizing element which is located on the third side;
the second guiding assembly further includes a fourth stabilizing element corresponding to the third stabilizing element;
when viewed along the main axis, the movable part has a polygonal structure, corresponding to the fixed assembly.

9. The optical element driving mechanism as claimed in claim 8, wherein
when viewed along the main axis, the movable part has an outward-facing side corresponding to the third side;
the fourth stabilizing element is disposed on the outward-facing side;
the third stabilizing element and the fourth stabilizing element are magnetic elements;
a second stabilizing force is generated between the third stabilizing element and the fourth stabilizing element and is configured to push the movable part along the first axis;
the second stabilizing force is a magnetic repulsion force;
the second stabilizing force is not perpendicular to the first stabilizing force.

10. The optical element driving mechanism as claimed in claim 3, wherein
when viewed along the main axis, the minimum distance between the center of the first supporting element and the first central line of the first side is greater than the minimum distance between the center of the first stabilizing element and the first central line;
the optical element driving mechanism further includes a second guiding assembly configured to guide the movable part to move relative to the fixed assembly;
the second guiding assembly includes a second supporting element, a second corresponding element and a second contact portion;
the first stabilizing force is configured to drive the movable part toward the second supporting element;
the second corresponding element has a second accommodating space configured to accommodate at least a portion of the second supporting element;
the second contact portion is located on the second corresponding element and is in contact with the second supporting element;
the second corresponding element and the first corresponding element have different structures;
the second contact portion and the first contact portion have different structures.

11. The optical element driving mechanism as claimed in claim 10, wherein
the first contact portion has a first contact surface and a second contact surface;
the first contact surface and the second contact surface are configured to be in contact with the first supporting element;
the first contact surface is connected to the second contact surface;
the first contact surface is not parallel to the second contact surface;
when viewed along the main axis, the first contact surface and the second contact surface form a V-shaped structure.

12. The optical element driving mechanism as claimed in claim 11, wherein
the second contact portion has a third contact surface, a fourth contact surface and a fifth contact surface;
the third contact surface, the fourth contact surface and the fifth contact surface are configured to be in contact with the second supporting element;
the fourth contact surface is connected between the third contact surface and the fifth contact surface;
the third contact surface is not parallel to the fourth contact surface;
the third contact surface is parallel to the fifth contact surface;
when viewed along the main axis, the third contact surface, the fourth contact surface and the fifth contact surface form a half rectangular structure.

13. The optical element driving mechanism as claimed in claim 12, wherein
when viewed along the main axis, the first corresponding element and the second corresponding element respectively have a first open structure and a second open structure;
when viewed along the main axis, an opening direction of the first open structure is different from an opening direction of the second open structure;
when viewed along the main axis, the opening direction of the first open structure is not parallel to the opening direction of the second open structure.

14. The optical element driving mechanism as claimed in claim 13, wherein
when viewed along the main axis, the second supporting element is located on the second side;
when viewed along the main axis, a minimum distance between a center of the second supporting element and a second central line of the second side is different from a minimum distance between the center of the first supporting element and the first central line;
when viewed along the main axis, the minimum distance between the center of the second supporting element and the second central line is less than the minimum distance between the center of the first supporting element and the first central line.

15. The optical element driving mechanism as claimed in claim 14, wherein
the driving assembly includes a transmission element which extends along the main axis;
when viewed along the main axis, a distance between a center of the transmission element and the center of the first supporting element is different from a distance between the center of the transmission element and the center of the second supporting element;
when viewed along the main axis, the distance between the center of the transmission element and the center of the first supporting element is greater than the distance between the center of the transmission element and the center of the second supporting element.

16. The optical element driving mechanism as claimed in claim 3, wherein
the driving assembly includes a driving source, a transmission element, a collaborative element and a clamping member;
the collaborative element corresponds to the driving source and generates a driving force with the driving source;
the transmission element is configured to transmit the driving force;
the clamping member corresponds to the transmission element;
when viewed along the main axis, a center connection line which connects the center of the first supporting element to a center of the transmission element passes through the optical element;
when viewed along a second axis, the movable part has at least one supporting portion which extends toward the transmission element along the first axis;
the second axis is perpendicular to the first axis;
the supporting portion is configured to support the transmission element when the movable part moves.

17. The optical element driving mechanism as claimed in claim 16, wherein
the fixed assembly has a first surface which faces the movable part;
the movable part has a second surface which faces the first surface;
the first surface is not parallel to the second surface;
the first surface is not perpendicular to the second surface.

18. The optical element driving mechanism as claimed in claim 17, wherein
when viewed along the main axis, an angle between the first surface and the second surface is less than 5 degrees;
when viewed along the main axis, the first surface and the second surface are both located on the first side;
the first stabilizing force is applied to the movable part and generates a first torque around the transmission element which serves as a rotating axis;
the first torque causes the second surface to move closer to the first surface.

19. The optical element driving mechanism as claimed in claim 16, wherein
the optical element driving mechanism further includes a position sensing assembly configured to sense motion of the movable part;
the second stabilizing element is disposed on the movable part;
the position sensing assembly corresponds to the second stabilizing element;
the second stabilizing element has a magnetic material;
the position sensing assembly includes a sensor configured to sense changes in the magnetic field of the second stabilizing element;
the sensor is disposed on the fixed assembly;
when viewed along a second axis, the sensor and the second stabilizing element are arranged along the main axis;
the second axis is perpendicular to the first axis.

20. The optical element driving mechanism as claimed in claim 19, wherein
the optical element driving mechanism further includes a protective element which is disposed on the fixed assembly;
the protective element has a columnar structure which extends along the main axis;
the protective element is configured to pass through the movable part;
when viewed along the main axis, a first quadrant, a second quadrant, a third quadrant and a fourth quadrant are defined when the main axis serves as the origin;
when viewed along the main axis, the protective element and the transmission element are located in the fourth quadrant.
